(19) United States
(12) Patent Application Publication
(10) Pub. No.: US 2014/0233945 A1
(43) Pub. Date: Aug. 21, 2014

(54) WAVELENGTH DIVISION MULTIPLEXING OPTICAL TRANSMITTING APPARATUS AND OPERATING METHOD OF THE SAME

(71) Applicant: Electronics and Telecommunications Research Institute, Daejeon (KR)

(72) Inventors: Jong Sool JEONG, Daejeon (KR); Hyun Soo KIM, Daejeon (KR); Mi-Ran PARK, Daejeon (KR); Byung-Seok CHOI, Daejeon (KR); O-Kyun KWON, Daejeon (KR)

(73) Assignee: Electronics and Telecommunications Research Institute, Daejeon (KR)

(21) Appl. No.: 14/185,351

(22) Filed: Feb. 20, 2014

(30) Foreign Application Priority Data
Feb. 21, 2013 (KR) 10-2013-0018754

(51) Int. Cl. H04J 14/02; H04B 10/079

(52) U.S. Cl. CPC H04J 14/0221; H04B 10/07955
USPC 398/34; 398/90

(57) ABSTRACT

Provided is a wavelength division multiplexing (WDM) optical transmitting apparatus including first to n-th optical transmitters configured to output first to n-th optical signals having different wavelengths, respectively; a wavelength multiplexer configured to multiplex the first to n-th optical signals and generate an output optical signal; a tap coupler configured to receive the output optical signal and generate a controlling optical signal based on some of the output optical signal; a controlling photodetector configured to receive the controlling optical signal and output an optical current based on the controlling optical signal; and a controller configured to control each of the first to n-th optical transmitters based on the optical current, wherein the controller comprises a look-up table, sequentially detects driving conditions for the first to n-th optical transmitters, stores the detected driving conditions in the look-up table, and controls the first to n-th optical transmitters based on the detected driving conditions.

### CROSS-REFERENCE TO RELATED APPLICATIONS

A claims for priority under 35 U.S.C. §119 is made to Korean Patent Application No. 10-2013-0018754, filed on Feb. 21, 2013, in the Korean Intellectual Property Office, the entire contents of which are hereby incorporated by reference.

### BACKGROUND OF THE INVENTION

The present invention disclosed herein relates to an optical communication and, more particularly, to a wavelength division multiplexing (WDM) optical transmitting apparatus and an operating method for the same.

Optical communication is a kind of communication, which uses an optical wave generated by a laser or a light emitting diode as a carrier wave. The optical communication uses a path, such as, a space, an optical fiber, an optical waveguide, or a beam guide, through which the optical wave travels as a transmission medium. The optical communication may obtain wideband transmission characteristics by modulating light intensity or using pulse code modulation (PCM). Recently, as an optical fiber having low information loss ratio and a semiconductor laser having improved performance are developed, the optical communication becomes used in various fields.

In particular, in a width division modulation (WDM) scheme, optical signals are assigned to a plurality of channels and then multiplexed to be transmitted through one optical fiber. That is, the WDM scheme can increase a communication bandwidth in an existing network by transmitting a plurality of optical signals together. An optical communication network based on the WDM scheme includes an optical line terminal (OLT) of a central base station, an optical network unit (ONU), and an optical distribution network connecting the OLT and the ONU. There are various network configurations according to connection relationship among the OLT, the ONU, and the optical distribution network. Recently, a WDM optical communication network configuration is well known which uses difference wavelength bands by separating wavelength bands of an uplink signal and a downlink signal.

An optical transmitting apparatus used in the OLT and ONU includes an optical filter for wavelength band separation, an optical transmitter, and an optical receiver. In this case, as a wavelength separation band is narrower, it is technically difficult to implement the optical filter for wavelength band separation. Accordingly, when uplink WDM optical signals are used as C-band wavelength signals and downlink WDM optical signals are used as L-band wavelengths, a way separating OLT-wavelength multiplexer/wavelength demultiplexer is mainly adopted. For example, the wavelength multiplexer, which wavelength-multiplexes the downlink WDM optical signals, is separated from the wavelength demultiplexer which wavelength-demultiplexes the uplink WDM optical signals.

However, the above-described ways and apparatuses for controlling optical outputs and wavelengths in an optical transmitter has limitations, such as an increase in a system size, a complex structure, an increase in cost, and performance degradation.

### SUMMARY OF THE INVENTION

The present invention provides a wavelength division multiplexing optical transmitting apparatus and an operating method of the same for detecting some of optical signals output from the optical transmitting apparatus and controlling driving conditions for optical transmitters included in the optical transmitting apparatus on the basis of the detected optical signals.

One aspect of exemplary embodiments of the present invention is directed to provide a wavelength division multiplexing (WDM) optical transmitting apparatus. The WDM optical transmitting apparatus comprises first to n-th optical transmitters configured to output first to n-th optical signals having different wavelengths, respectively; a wavelength multiplexer configured to multiplex the first to n-th optical signals and generate an output optical signal; a tap coupler configured to receive the output optical signal and generate a controlling optical signal based on some of the output optical signal; a controlling photodetector configured to receive the controlling optical signal and output an optical current based on the controlling optical signal; and a controller configured to control each of the first to n-th optical transmitters based on the optical current. The controller comprises a look-up table, sequentially detects driving conditions for the first to n-th optical transmitters, stores the detected driving conditions in the look-up table, and controls the first to n-th optical transmitters based on the detected driving conditions.

In exemplary embodiments, each of the first to n-th optical transmitters comprises a driving unit configured to output a control signal according to a control by the controller; a laser diode configured to output the first to n-th optical signals respectively according to the control signal; and a monitoring photodetector configured to output a current to the controller on the basis of some of the first to n-th optical signals, respectively.

In exemplary embodiments, the driving conditions comprises current values of the controlling photodetector, which correspond respectively to the first to n-th optical transmitters, wavelength values of the first to n-th optical signals output respectively from the first to n-th optical transmitters, and control signal values for the first to n-th optical transmitters.

In exemplary embodiments, the controller is configured to select any one of the first to n-th optical transmitters, adjust an output of the selected optical transmitter as a reference power, and detect a wavelength value of an optical signal which is output from the selected optical transmitter when a current value from the controlling photodetector according to an optical power of an optical signal from the selected optical transmitter is a maximum.

In exemplary embodiments, the WDM optical transmitting apparatus of claim 1, further comprising a low frequency electrical filter configured to filter the current output from the controlling photodetector. The first to n-th optical transmitters respectively further comprise a low frequency electrical signal generating unit configured to output a low frequency electric signal.

In exemplary embodiments, the controller is configured to select any one of the first to n-th optical transmitters, enable the low frequency electrical signal generating unit included in the selected optical transmitter, detect the driving conditions for the selected optical transmitter based on the filtered current output from the low frequency electrical filter, and update the look-up table based on the detected driving conditions.

In exemplary embodiments, the low frequency electrical signal has a frequency within 0.8 to 1.2 kHz.

Another aspect of exemplary embodiments of the present invention is directed to provide a method of operating a WDM optical transmitting apparatus including a plurality of optical transmitters. The method comprises selecting any one of the plurality of optical transmitters to enable the selected optical transmitter, to disable other optical transmitters except the selected optical transmitter; adjusting an optical power of an optical signal output from the selected optical transmitter as a reference power; detecting a wavelength of the optical signal that allows a value of a current, which is output from a controlling photodetector according to the optical signal output from the selected optical transmitter, to be a maximum; adjusting the optical power of the optical signal output from the selected optical transmitter as a normal power; detecting driving conditions for the optical transmitter adjusted as the normal power; and storing the detected driving conditions in a look-up table.

In exemplary embodiments, the driving conditions comprise a control signal of the selected optical transmitter, information on the detected wavelength, current values from the controlling photodetector configured to detect output optical signals, and current values from a monitoring photodetector configured to detect optical signals output from the selected optical transmitter.

In exemplary embodiments, the reference power is lower than the normal power.

In exemplary embodiments, the method further comprises driving the plurality of optical transmitters based on the look-up table; selecting any one of the plurality of driven optical transmitters; controlling a wavelength of the selected optical transmitter; and detecting wavelength conditions allowing a current value of the controlling photodetector to be a maximum; and updating the look-up table based on the detected current value.

In exemplary embodiments, the plurality of driven optical transmitters is in the middle of performing optical communication with an external device based on the look-up table.

In exemplary embodiments, each of the plurality of optical transmitters performs optical communication with external devices through a plurality of channels, and the plurality of channels respectively provides transmission paths of optical signals having difference wavelength ranges.

Another aspect of exemplary embodiments of the present invention is directed to provide an operating method of a WDM optical transmitting apparatus including a plurality of optical transmitters. The method comprises selecting any one of the plurality of optical transmitters to enable a low frequency electrical signal generating unit included in the selected optical transmitter, to disable low frequency electrical signal generating units included in unselected optical transmitters; detecting wavelength conditions of the selected optical transmitter that allows a current value of a controlling photodetector to be a maximum based on a low frequency electrical signal output from the enabled electrical signal generating unit; adjusting an optical power of an optical signal output from the selected optical transmitter as a normal power; and updating driving conditions of the selected optical transmitter in a look-up table.

In exemplary embodiments, the detecting the wavelength conditions comprises generating, by the selected optical transmitter, a low frequency optical signal on the basis of the low frequency electrical signal; outputting, by the controlling photodetector, a current on the basis of the generated low frequency optical signal; and low-frequency-filtering the output current and detecting the wavelength conditions of the selected optical transmitter when the filtered out current is a maximum.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a wavelength division multiplexing (WDM) optical transmitting apparatus according to an embodiment of the present invention;

FIG. 2 is a block diagram illustrating the first optical transmitter shown in FIG. 1;

FIG. 3 is a flowchart illustrating an operation of the WDM optical transmitting apparatus shown in FIG. 1;

FIG. 4 is a flowchart illustrating an operation of a WDM optical transmitting apparatus according to another embodiment of the present invention;

FIG. 5 is a block diagram illustrating a WDM optical transmitting apparatus according to still another embodiment of the present invention;

FIG. 6 is a block diagram illustrating the first optical transmitter shown in FIG. 5; and

FIG. 7 is a flowchart illustrating an operation of the WDM optical transmitting apparatus shown in FIG. 5.

### DETAILED DESCRIPTION OF PREFERRED EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, third etc. may be used herein to describe various elements, these elements should not be limited by these terms. These terms are used to distinguish one element from another. Thus, a first element discussed below could be termed a second element without departing from the teachings of inventive concepts.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

The terminology used herein is for the purpose of describing particular example embodiments only and is not intended to be limiting of inventive concepts. As used herein, the singular forms “a,” “an” and “the” are intended to include the plural forms as well, unless the context clearly indicates otherwise. It will be further understood that the terms “comprises”, “comprising”, “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

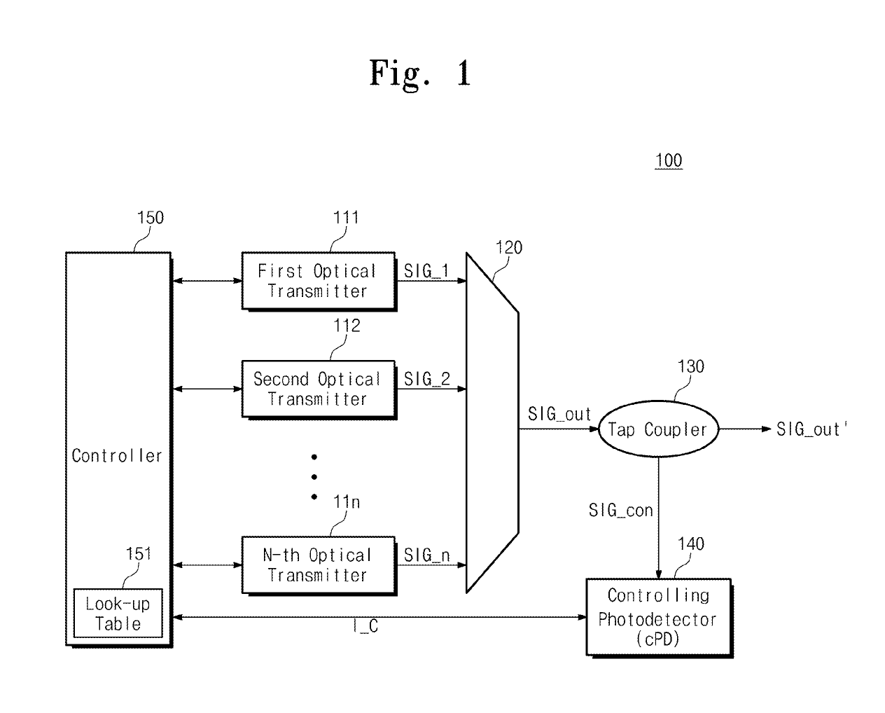

FIG. 1 is a block diagram illustrating a wavelength division multiplexing (WDM) optical transmitting apparatus according to an embodiment of the present invention. Referring to FIG. 1, the WDM optical transmitting apparatus 100 may operate on the basis of first to n-th channels. The first to n-th channels may include transmission paths for optical signals having different wavelength ranges, respectively. The WDM optical transmitting apparatus 100 includes first to n-th optical transmitters 111 to 11n, a wavelength multiplexer 120, a tap coupler 130, a control photodetector (cPD) 140, and a controller 150.

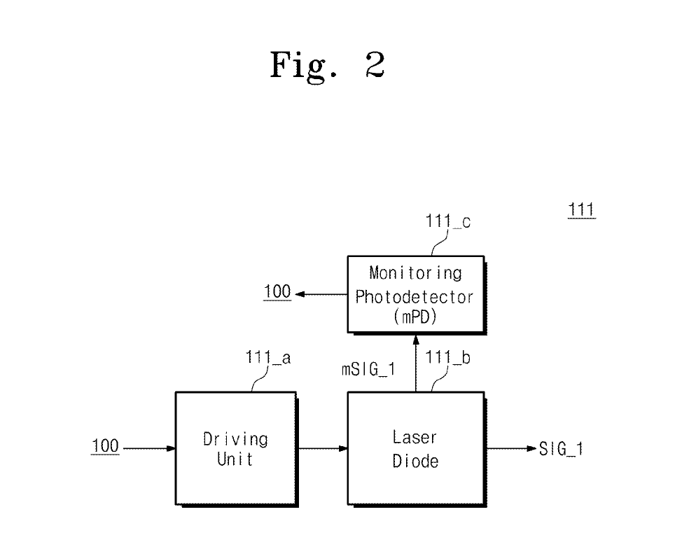

The first to n-th optical transmitters 111 to 11n may generate first to n-th optical signals SIG_1 to SIG_{—}n respectively corresponding to the first to n-th channels. For example, the first to n-th optical transmitters 111 to 11n may generate the first to n-th optical signals SIG_1 to SIG_{—}n having different wavelengths, respectively. The generated first to n-th optical signals SIG_1 to SIG_{—}n are transmitted to the wavelength multiplexer 120. The first to n-th optical transmitters 111 to 11n will described in detail in relation to FIG. 2.

The wavelength multiplexer 120 may receive the first to n-th optical signals SIG_1 to SIG_{—}n output from the first to n-th optical transmitters 111 to 11n. The wavelength multiplexer 120 multiplexes the received first to n-th optical signals SIG_1 to SIG_{—}n to generate an output optical signal SIG_out. The generated output optical signal SIG_out may be transmitted to the tap coupler 130.

The tap coupler 130 may decouple some of the output optical signal SIG_out output from the wavelength multiplexer 120 to generate a controlling optical signal SIG_con. The tap coupler 130 transmits the generated controlling optical signal SIG_con to the controlling photodetector(cPD) 140. Other output optical signal SIG_out′ except the controlling optical signal SIG_con may be transmitted to an external device.

The cPD 140 may convert optical power of the controlling optical signal SIG_con received from the tap coupler 130 into electrical power. For example, the cPD 140 may absorb the controlling optical signal SIG_con. The cPD 140 may output a current according to optical power of the absorbed controlling optical signal SIG_con. In exemplary embodiments, the cPD 140 may be a device such as a photo diode, or an Avalanche photo diode.

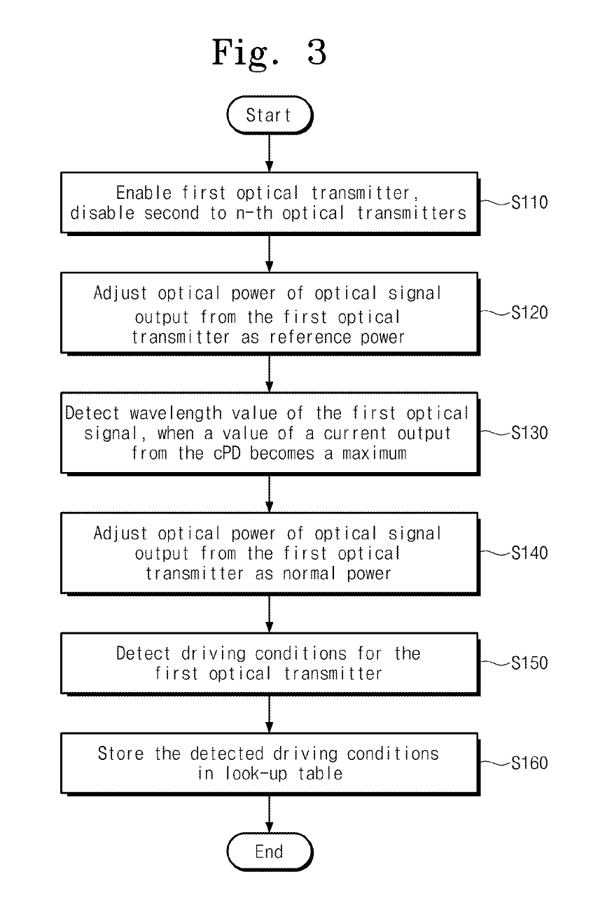

The controller 150 may control the first to n-th optical transmitter 111 to 11n in the basis of a value of the current output from the cPD 140. The controller 150 may include a look-up table 151. The look-up table 151 may include driving condition information on components included in the WDM optical transmitting apparatus 100. The driving condition information may be information for a normal operation of the WDM optical transmitting apparatus 100. An operation of the controller 150 and a configuration way of the look-up table 151 will be described in relation to FIGS. 3 to 5.

FIG. 2 is a block diagram illustrating the first optical transmitter 111 shown in FIG. 1. Although not shown in the drawing, the second to n-th optical transmitters 112 to 11n of FIG. 1 may also have the same configuration as that of the first optical transmitter 111 as shown in FIG. 2

Referring to FIG. 2, the first optical transmitter 111 may output the first optical signal SIG_1 by control of the controller 150 (see FIG. 1). The first optical transmitter 111 includes a driving unit 111_{—}a, a laser diode 111_{—}b, and a monitoring photodetector(mPD) 111_{—}c. The driving unit 111_{—}a may control the laser diode 111_{—}b. For example, when the controller 150 enables the first optical transmitter 111, the driving unit 111_{—}a may control a wavelength and an optical output of the first optical signal SIG_1 output from the laser diode 111_{—}b. When the controller 150 disables the first optical transmitter 111, the driving unit 111_{—}a may control the laser diode 111_{—}b so that the first optical signal SIG_1 is not output.

The laser diode 111_{—}b may output the first optical signal SIG_1 on the basis of a control signal (e.g. an electrical signal) output from the driving unit 111_{—}a. In exemplary embodiments, the laser diode 111_{—}b may output a first monitoring optical signal mSIG_1. The first monitoring optical signal mSIG_1 may be an optical signal having the same wavelength as that of the first optical signal SIG_1 output from the laser diode 111_{—}b. In other words, some of the first optical signal SIG_1 may be output as the first monitoring optical signal mSIG_1.

The mPD 111_{—}c may convert optical power of the first monitoring optical signal mSIG_1 received from the laser diode 111_{—}b into electrical power. For example, the mPD 111_{—}c outputs a current according to the optical power of the first monitoring optical signal mSIG_1. The current of the first monitoring optical signal mSIG_1 may be transmitted to the controller 150 (see FIG. 1). In exemplary embodiments, the driving unit 111_{—}a, the laser diode 111_{—}b, or the mPD 111_{—}c may be provided as one chip or one module.

FIG. 3 is a flowchart illustrating a method of operating an optical transmitting apparatus according to an embodiment of the present invention. In exemplary embodiments, in the method of operating the optical transmitting apparatus shown in FIG. 3, a method of generating the look-up table 151 is described on the basis of the first optical transmitter 111 performing communication through the first channel. However, the present invention is not limited hereto, and the optical transmitting apparatus 100 may detect driving conditions for the rest of the optical transmitters 112 to 11n except the first optical transmitter 111 on the basis of the operating method shown in FIG. 3.

Referring to FIG. 3, in operation S110, the optical transmitting apparatus 100 may enable the first optical transmitter 111 corresponding to the first channel and disable the rest of the optical transmitters. For example, the controller 150 may control the rest of the transmitters so that optical signals are not generated from the rest of the optical transmitters except the first optical transmitter 111.

In operation S 120, the optical transmitting apparatus 100 may control the first optical transmitter 111 to allow optical power output from the first optical transmitter 111 to be a reference power. For example, the first optical transmitter may output the first optical signal SIG_1. The wavelength multiplexer 120 may multiplex the first optical signal SIG_1 and output as the output optical signal SIG_out. In this case, the controller 150 may control the first optical transmitter 111 to allow optical power of the output optical signal SIG_out to be the reference power. In exemplary embodiments, the reference power may have a lower level than a normal power of the optical transmitting apparatus 100. The normal power indicates an optical power of optical output that the optical transmitting apparatus 100 may normally perform optical communication with an external device.

In operation S130, the optical transmitting apparatus 100 may detect a wavelength value of the first optical signal SIG_1, when a value of a current output from the cPD 140 becomes a maximum by adjusting a wavelength of the first optical signal output from the first optical transmitter 111. For example, the first to k-th channels may respectively provide transmission paths for optical signals having different wavelength ranges. That is, the controller 150 may adjust a wavelength of the first optical signal SIG_1 within a wavelength range of the first channel. At this time, according to a wavelength change of the first optical signal SIG_1, a value of the current output from the cPD 140 may be changed. The controller 150 may detect a wavelength value that the value of the current output from the cPD 140 within the wavelength range of the first channel becomes a maximum. For example, the greater the current value from the cPD 140 is, the higher an absorption ratio of the controlling optical signal absorbed by the cPD 140 is. In other words, the greater the current value from the cPD 140, the output optical signal may be stably transmitted to an external device.

In operation S140, the optical transmitting apparatus 100 may control the first optical transmitter 111 to allow an optical power of the first optical signal SIG_1 output from the first optical transmitter 111 to be a normal power.

In operation S150, the optical transmitting apparatus 100 may detect driving conditions for the optical transmitter 111. The driving conditions for the first optical transmitter indicate the control signal value and the wavelength value of the first optical transmitter 111, the current value of the mPD 111_{—}c, and the current value of the cPD 140. For example, the control signal value of the first transmitter 111 may indicate a control signal of the driving unit 111_{—}a which controls the first optical transmitter 111 to allow an optical power of the first optical signal SIG_1 to be a normal power. The wavelength value of the first optical transmitter 111 indicates wavelength conditions of the first optical signal SIG_1 that a value of the current output from the cPD 140 becomes the maximum in operation S 130. The current value of the cPD 140 may indicate an optical power of the output optical signal SIG_out. The current value of the mPD 111_{—}c may indicate an optical power of the first optical signal SGI_1 output from the first optical transmitter 111.

In operation S160, the WDM optical transmitting apparatus 100 may store driving conditions for the first optical transmitter 111 in the look-up table 151.

In exemplary embodiments, the WDM optical transmitting apparatus 100 may store driving conditions for the second to n-th optical transmitters 112 to 11n in the look-up table 151 on the basis of the method described in relation to operations S110 to S160. The WDM optical transmitting apparatus 100 may control the first to n-th optical transmitters 111 to 11n on the basis of the look-up table 151 including the driving conditions for the first to n-th optical transmitters 111 to 11n.

In exemplary embodiments, the WDM optical transmitting apparatus 100 may periodically update the look-up table 151. Alternatively, when constant idle times occur, the WDM transmitting apparatus 100 may update the look-up table 151.

According to the above-described embodiments of the present invention, the WDM optical transmitting apparatus 100 may adjust the driving conditions for the first to n-th optical transmitters 111 to 11n. In this case, performance degradation of the WDM optical transmitting apparatus 100 may be prevented which occurs when characteristics of the components included in the

WDM optical transmitting apparatus 100 are changed due to aging effects or external causes.

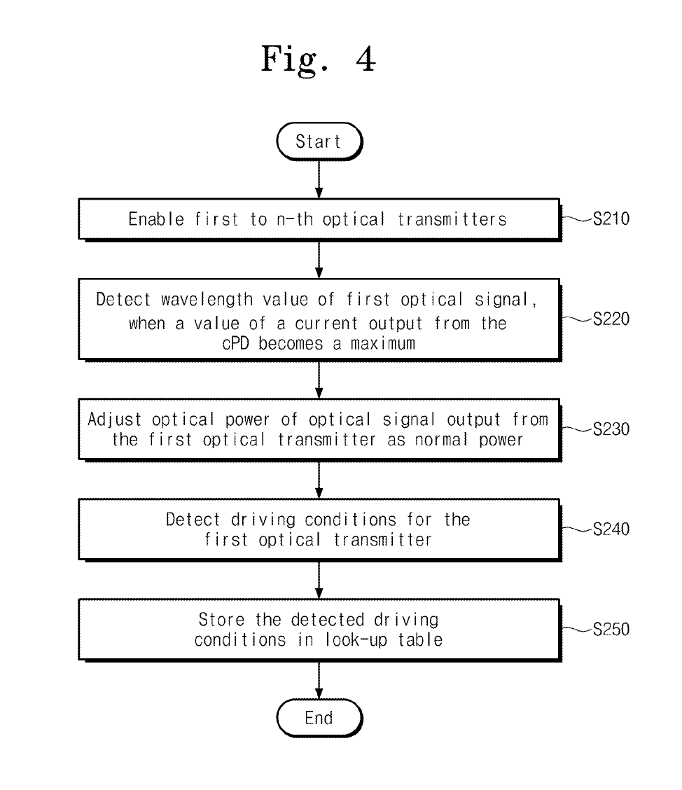

FIG. 4 is a flowchart illustrating operations of the WDM optical transmitting apparatus according to another embodiment of the present invention. For example, operations of the optical transmitting apparatus 100 controlling the first optical transmitter 111 are described in relation to FIG. 4. However, a scope of the present invention is not limited hereto, and the WDM optical transmitting apparatus 100 may control the second to n-th optical transmitters 112 to 11n identically with the method shown in FIG. 4. For example, according to operations of the WDM optical transmitting apparatus 100 shown in FIG. 3, the WDM optical transmitting apparatus 100 may update the look-up table 151, while performing communication with an external device, which is different from operations of the optical transmitting apparatus shown in FIG. 2.

Referring to FIG. 4, in operation S210, the WDM optical transmitting apparatus 100 may enable the first to n-th optical transmitters 111 to 11n. For example, the WDM optical transmitting apparatus 100 may control the first to n-th optical transmitters 111 to 11n on the basis of the driving conditions for the first to n-th optical transmitters 111 to 11n, which are stored in the look-up table 151. For example, the look-up table 151 may be generated in advance on the basis of a method described in relation to FIG. 3.

In operation S220, the WDM optical transmitting apparatus 100 may detect a wavelength value of the first optical transmitter 111 when a value of the current output from the cPD 140 becomes a maximum. For example, the controller 150 may control the wavelength of the first optical signal SIG_1 within a wavelength range of the first channel and detect the wavelength value when the value of the current output from the cPD 140 becomes the maximum.

Since operations S230 to S250 are the same as operations S140 to S160 of the flowchart shown in FIG. 3, their description is omitted. For example, driving conditions for other optical transmitters 112 to 11n except the first optical transmitter 111 may be also detected by the method described in relation to FIG. 4.

According to the other embodiment of the present invention as described above, the WDM optical transmitting apparatus 100 may detect driving conditions for the first to n-th optical transmitters 111 to 11n, while performing optical communication with an external device. Accordingly, an optical transmitting apparatus having improved performance and stability is provided.

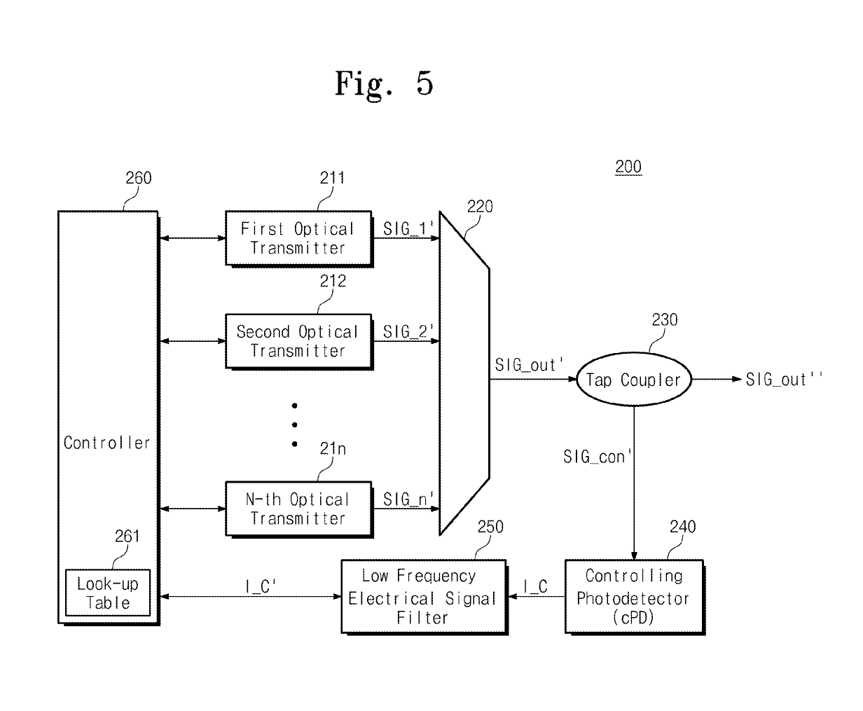

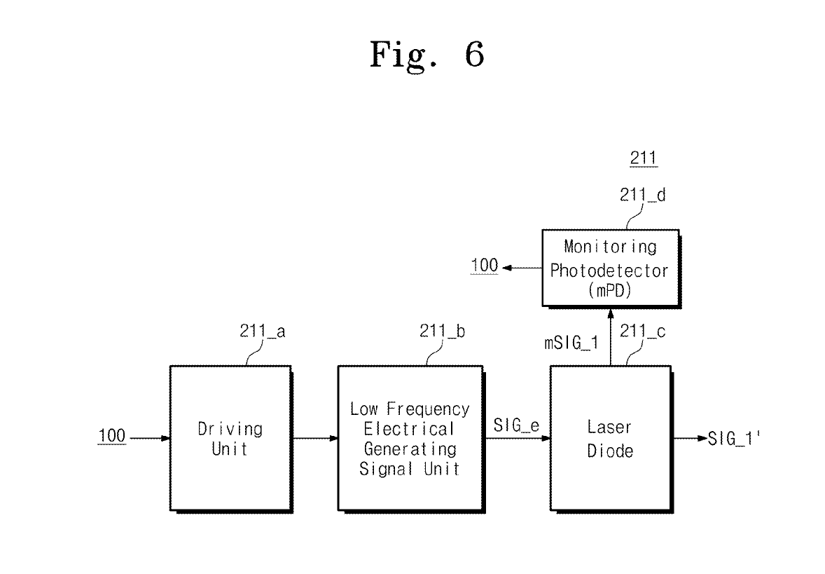

FIG. 5 is a block diagram illustrating a WDM optical transmitting apparatus according to still another embodiment of the present invention. FIG. 6 is a block diagram illustrating the first optical transmitter 211 of FIG. 5. Referring to FIGS. 5 and 6, the WDM optical transmitting apparatus 200 includes first to n-th optical transmitters 211 to 21n, a wavelength multiplexer 220, a tap coupler 230, a cPD 240, a low frequency electrical signal filer 250, and a controller 260. The first optical transmitter 211 may include a driving unit 211_{—}a, a low frequency electrical signal generating unit 211_{—}b, a mPD 211_{—}c, and a laser diode 211_{—}d. Although not shown in the drawing, the second to n-th optical transmitter 212 to 21n may also have the same configuration as that of the first optical transmitter 211 shown in FIG. 5.

The WDM optical transmitting apparatus 200 of FIG. 5 further includes the low frequency electrical signal generating unit 211_{—}b and the low frequency electrical signal filter 250 other than the WDM optical transmitting apparatus 100 of FIG. 1. Hereinafter, differences between the WDM optical transmitting apparatuses 200 and 100 of FIGS. 4 and 1 are mainly described.

The low frequency electrical signal generating unit 211_{—}b may generate a low frequency electrical signal SIG_{—}e. The generated low frequency electrical signal SIG_{—}e is transmitted to the laser diode 211_{—}c. For example, the electrical signal SIG_{—}e may be an electrical signal having a frequency of 0.8 to 1.2 kHz.

The laser diode 211_{—}c may output a first low frequency optical signal SIG_1′ according to the received low frequency electrical signal SIG_{—}e and a control by the driving unit 211_{—}a. In other words, the laser diode 211_{—}c may output the first low frequency electrical signal SIG_1′ on the basis of an electrical signal that a control signal output from the driving unit 211_{—}a and the low frequency electrical signal SIG_{—}e output from the low frequency electrical signal generating unit 211_{—}b. For example, the first low frequency optical signal SIG_1′ may include a component of the low frequency electrical signal SIG_{—}e.

The cPD 240 may receive a controlling optical signal SIG_con including the first low frequency optical signal SIG_1′ and generate a current on the basis of the received controlling optical signal SIG_con. The generated current is filtered through the low frequency electrical filter 250 and only a current corresponding to the low frequency electrical signal SIG_{—}e is output. The controller 260 may control the first optical transmitter 211 on the basis of the filtered out current.

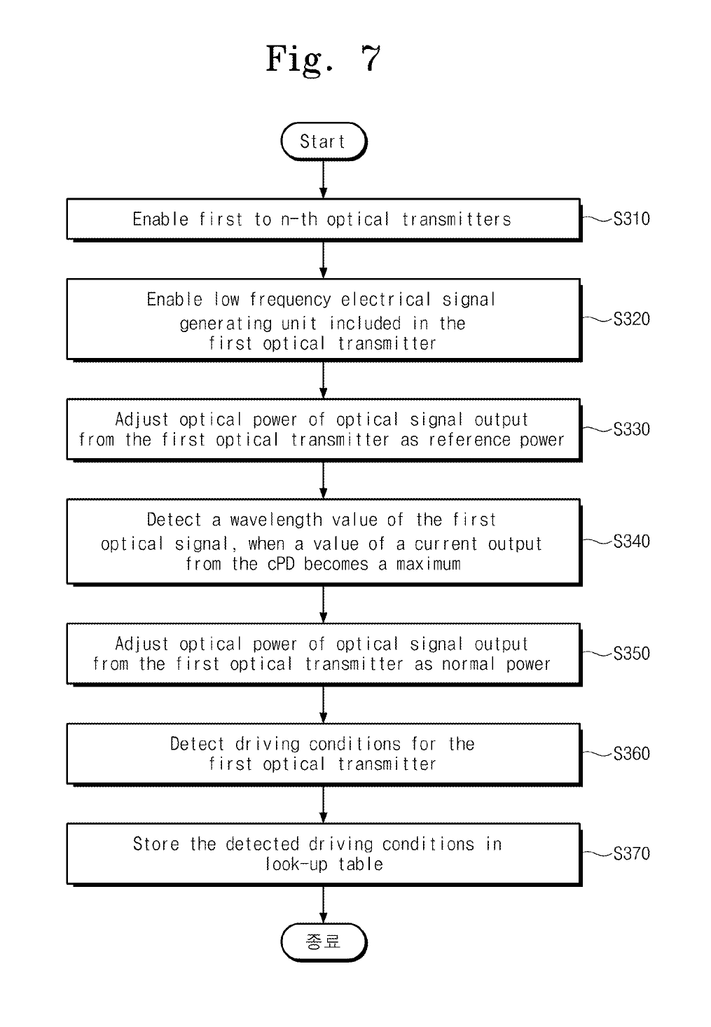

FIG. 7 is a flowchart illustrating operation of the WDM optical transmitting apparatus 200 shown in FIG. 5. Referring to FIG. 7, in operation S310, the WDM optical transmitting apparatus 200 may enable the first to n-th optical transmitters 211 to 21n. The first to n-th optical transmitters 211 to 21n may output the first to n-th optical signals SIG_1 to SIG_{—}n in order to perform optical communication with an external device.

In operation S320, the WDM optical transmitting apparatus 200 may enable the low frequency electrical signal generating unit 211_{—}b included in the first optical transmitter 211, and disable low frequency electrical signal generating units included in the second to n-th optical transmitter 211 to 21n.

In operation S330, the WDM optical transmitting apparatus 200 may control the first optical transmitter 211 to allow an optical power of the first low frequency optical signal output from the first optical transmitter 211 to be a reference power. For example, the reference power may be lower than the normal power of the WDM optical transmitting apparatus 200.

In operation S340, the WDM optical transmitting apparatus 200 may detect wavelength conditions for the first low frequency optical signal SIG_1′ that allows a current corresponding to the low frequency electrical signal SIG_{—}e among currents output from the cPD 240 to be a maximum. For example, the first low frequency optical signal SIG_1′ output from the first optical transmitter 211 may include a component of the low frequency electrical signal SIG_{—}e. In this case, some of the current output from the cPD 240 may include the component of the low frequency electrical signal SIG_{—}e. The controller 260 may detect wavelength conditions of the first low frequency optical signal SIG_1′ that allows a current output from the cPD 240 to be a maximum of a current filtered through the low frequency electrical filter 250.

Operations S350 to S370 are the same as operations S140 to S160 of FIG. 1 and thus, their description is omitted.

According to the above described other embodiment, the WDM optical transmitting apparatus can detect driving conditions for a plurality of optical transmitters by using the low frequency electrical signal. Accordingly, the WDM optical transmitting apparatus having improved performance and stability can be provided.

According to the embodiments of the present invention, the WDM optical transmitting apparatus can handle characteristic changes of the WDM optical transmitting apparatus due to an aging effect and external causes by controlling driving conditions for a plurality of optical transmitters performing communication through a plurality of channels. Accordingly, a WDM optical transmitting apparatus having reduced cost and improved performance can be provided

According to embodiments of the present invention, the WDM optical transmitting apparatus and operating method of the same can reduce a cost, and have improved reliability and performance by adjusting driving conditions for a plurality of optical transmitters included in the WDM optical transmitting apparatus on a basis of some of optical signals output from the WDM optical transmitting apparatus.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wavelength division multiplexing (WDM) optical transmitting apparatus comprising:
first to n-th optical transmitters configured to output first to n-th optical signals having different wavelengths, respectively;
a wavelength multiplexer configured to multiplex the first to n-th optical signals and generate an output optical signal;
a tap coupler configured to receive the output optical signal and generate a controlling optical signal based on some of the output optical signal;
a controlling photodetector configured to receive the controlling optical signal and output an optical current based on the controlling optical signal; and
a controller configured to control each of the first to n-th optical transmitters based on the optical current,
wherein the controller comprises a look-up table, sequentially detects driving conditions for the first to n-th optical transmitters, stores the detected driving conditions in the look-up table, and controls the first to n-th optical transmitters based on the detected driving conditions.

2. The WDM optical transmitting apparatus of claim 1, wherein each of the first to n-th optical transmitters comprises:
a driving unit configured to output a control signal according to a control by the controller;
a laser diode configured to output the first to n-th optical signals respectively according to the control signal; and
a monitoring photodetector configured to output a current to the controller on the basis of some of the first to n-th optical signals, respectively.

3. The WDM optical transmitting apparatus of claim 2, wherein the driving conditions comprises current values of the controlling photodetector, which correspond respectively to the first to n-th optical transmitters, wavelength values of the first to n-th optical signals output respectively from the first to n-th optical transmitters, and control signal values for the first to n-th optical transmitters.

4. The WDM optical transmitting apparatus of claim 1, wherein the controller is configured to select any one of the first to n-th optical transmitters, adjust an output of the selected optical transmitter as a reference power, and detect a wavelength value of an optical signal which is output from the selected optical transmitter when a current value from the controlling photodetector according to an optical power of an optical signal from the selected optical transmitter is a maximum.

5. The WDM optical transmitting apparatus of claim 1, further comprising a low frequency electrical filter configured to filter the current output from the controlling photodetector,
wherein the first to n-th optical transmitters respectively further comprise a low frequency electrical signal generating unit configured to output a low frequency electric signal.

6. The WDM optical transmitting apparatus of claim 5, wherein the controller is configured to select any one of the first to n-th optical transmitters, enable the low frequency electrical signal generating unit included in the selected optical transmitter, detect the driving conditions for the selected optical transmitter based on the filtered current output from the low frequency electrical filter, and update the look-up table based on the detected driving conditions.

7. The WDM optical transmitting apparatus of claim 6, wherein the low frequency electrical signal has a frequency within 0.8 to 1.2 kHz.

8. A method of operating a WDM optical transmitting apparatus including a plurality of optical transmitters, comprising:
selecting any one of the plurality of optical transmitters to enable the selected optical transmitter, to disable other optical transmitters except the selected optical transmitter;
adjusting an optical power of an optical signal output from the selected optical transmitter as a reference power;
detecting a wavelength of the optical signal that allows a value of a current, which is output from a controlling photodetector according to the optical signal output from the selected optical transmitter, to be a maximum;
adjusting the optical power of the optical signal output from the selected optical transmitter as a normal power;
detecting driving conditions for the optical transmitter adjusted as the normal power; and
storing the detected driving conditions in a look-up table.

9. The method according to claim 8, wherein the driving conditions comprise a control signal of the selected optical transmitter, information on the detected wavelength, current values from the controlling photodetector configured to detect output optical signals, and current values from a monitoring photodetector configured to detect optical signals output from the selected optical transmitter.

10. The method of claim 8, wherein the reference power is lower than the normal power.

11. The method of claim 8, further comprising:
driving the plurality of optical transmitters based on the look-up table;
selecting any one of the plurality of driven optical transmitters;
controlling a wavelength of the selected optical transmitter; and
detecting wavelength conditions allowing a current value of the controlling photodetector to be a maximum; and
updating the look-up table based on the detected current value.

12. The method of claim 11, wherein the plurality of driven optical transmitters are in the middle of performing optical communication with an external device based on the look-up table.

13. The method of claim 8, wherein each of the plurality of optical transmitters performs optical communication with external devices through a plurality of channels, and the plurality of channels respectively provides transmission paths of optical signals having difference wavelength ranges.

14. An operating method of a WDM optical transmitting apparatus including a plurality of optical transmitters, comprising:
selecting any one of the plurality of optical transmitters to enable a low frequency electrical signal generating unit included in the selected optical transmitter, to disable low frequency electrical signal generating units included in unselected optical transmitters;
detecting wavelength conditions of the selected optical transmitter that allows a current value of a controlling photodetector to be a maximum based on a low frequency electrical signal output from the enabled electrical signal generating unit;
adjusting an optical power of an optical signal output from the selected optical transmitter as a normal power; and
updating driving conditions of the selected optical transmitter in a look-up table.

15. The method of claim 14, wherein the detecting the wavelength conditions comprises:
generating, by the selected optical transmitter, a low frequency optical signal on the basis of the low frequency electrical signal;
outputting, by the controlling photodetector, a current on the basis of the generated low frequency optical signal; and
low-frequency-filtering the output current and detecting the wavelength conditions of the selected optical transmitter when the filtered out current is a maximum.
